(19) United States
(12) Patent Application Publication
(10) Pub. No.: US 2020/0087491 A1
(43) Pub. Date: Mar. 19, 2020

(54) THERMOPLASTIC CROSSLINKED POLYETHYLENE MATERIAL, PREPARATION METHOD AND USE THEREOF

(71) Applicant: MENRED GROUP CO., LTD., Yueqing (CN)

(72) Inventors: DONGMING YU, Yueqing (CN); ZHANGCHENG CHEN, Yueqing (CN); ZHI CHENG, Yueqing (CN); JUNZHENG XU, Yueqing (CN); MINGYUAN HU, Yueqing (CN); KAIGE DUAN, Yueqing (CN); CHAOXI ZHOU, Yueqing (CN); JIA NI, Yueqing (CN)

(21) Appl. No.: 16/243,454

(22) Filed: Jan. 9, 2019

(30) Foreign Application Priority Data
Sep. 14, 2018 (CN) 201811075835.8

(51) Int. Cl. C08L 23/06; C08L 23/08; C08J 3/20

(52) U.S. Cl. CPC C08L 23/06; C08L 23/0815; C08J 3/201; C08L 2201/08; B29C 48/022; C08L 2205/025; C08L 2207/062; C08L 2312/00; C08L 2203/18; C08L 2201/02

(57) ABSTRACT

The present application belongs to the field of polymer materials, discloses a thermoplastic crosslinked polyethylene material, preparation method and use thereof. The thermoplastic crosslinked polyethylene material comprises a first polyethylene component that is easily crosslinked, a second polyethylene component that is not easily crosslinked, and an organic peroxide crosslinking agent. In the present application, the product of the first polyethylene that is easily crosslinked, is crosslinked in a fine particle form and uniformly dispersed in the second polyethylene component that is not easily crosslinked, and intertwined with the macromolecular chain of the second polyethylene component that is not easily crosslinked. The resulted product is completely thermoplastic, and has properties, such as heat resistance and creep property, superior to the first polyethylene component that is easily crosslinked and the second polyethylene component that is not easily crosslinked.

### TECHNICAL FIELD

The present application belongs to the field of polymer materials, and relates to a modified polyethylene material, in particular to a thermoplastic crosslinked polyethylene material, preparation method and use thereof.

### BACKGROUND

Crosslinking technology refers to the technology of realizing crosslinking reaction of macromolecules by chemical means (such as adding crosslinking agent) or physical methods (such as irradiation) to make linear polymers into polymers with three-dimensional network structure. Crosslinking technology is an important technology to improve the performance of polyethylene (PE). The crosslinked polyethylene (PEX) obtained by crosslinking modification has comprehensive performances, such as mechanical property, heat resistance, creep property and wear resistance, that are greatly improved compared with PE, and thus the application range of which has been greatly expanded. However, in the prior art, PEX materials are generally obtained by crosslinking with high density polyethylene (referred to as “HDPE”), and the degree of crosslinking is specified to be 60%-70%. Such a high degree of crosslinking makes PEX completely lose its thermoplasticity, the connection of PEX pipes by hot-melt welding impossible, and at the same time PEX pipe scraps unrecoverable by hot-melt method. When the degree of crosslinking is low, PEX material retains parts of its thermoplasticity, but its heat resistance and creep resistance are not significantly improved compared with the raw material polyethylene.

Chinese patent document CN102875877A discloses a dynamic crosslinking modified heat resistant polyethylene material, preparation method and use thereof, wherein the crosslinking modified heat resistant polyethylene material comprises the raw materials of 5%-20% of a polyethylene powder, 0.1%-0.4% of a silane coupling agent, 0.01%-0.1% of an organic peroxide, 0.01%-0.04% of an organic tin, and remaining amount of heat resistant polyethylene. The method comprises the step of blending extrusion granulation of a silane crosslinking PE and heat resistant polyethylene material, to obtain a partially crosslinked thermoplastic crosslinked polyethylene material. However, the silane crosslinking reaction requires water or water-releasing compound in the reaction system, and the method of CN102875877A is not involved, so it is difficult to obtain the silane crosslinking PE by this method. In addition, the method uses an organotin compound as a catalyst, which is highly toxic and is harmful to human health and environmental protection.

### SUMMARY

The present application aims to provide a thermoplastic crosslinked polyethylene material, which has comprehensive performances, such as mechanical property, heat resistance, creep property and wear resistance close to PEX, and greatly improved heat resistance and creep resistance compared with an uncrosslinked polyethylene raw material. At the same time, the application also provides a preparation method of the thermoplastic crosslinked polyethylene material and use thereof.

To this end, the present application provides a thermoplastic crosslinked polyethylene material, wherein the thermoplastic crosslinked polyethylene material comprises the following raw materials in parts by weight:

30˜70 parts of a first polyethylene component;

30˜70 parts of a second polyethylene component; and

0.15˜0.35 part of a crosslinking agent;

the first polyethylene component is an ethylene homopolymer free of antioxidants or other free radical scavengers;

the second polyethylene component is an ethylene homopolymer containing antioxidants or other free radical scavengers, or a copolymer of ethylene and a non-ethylene monomer.

Further, the non-ethylene monomer is one or more of butene, hexene and octene.

Further, the thermoplastic crosslinked polyethylene material comprises the following raw materials in parts by weight:

35 parts of the first polyethylene component;

65 parts of the second polyethylene component; and

0.25 part of an organic peroxide crosslinking agent;

the first polyethylene component is an ethylene homopolymer free of antioxidants or other free radical scavengers;

the second polyethylene component is a copolymer of ethylene and hexene monomer.

Further, the organic peroxide crosslinking agent is one or more of di-tert-butane peroxide, 2,5-dimethyl-2,5-di-tert-butylperoxy-3-hexyne or di-tert-butylperoxy di isopropyl benzene.

Further, the thermoplastic crosslinked polyethylene material comprises an antioxidant, the antioxidant is dilauryl thiodipropionate and/or octadecyl 3-(3,5-di-tert-butyl-4-hydroxyphenyl)propionate.

Further, the thermoplastic crosslinked polyethylene material comprises one or more of a conductive auxiliary agent, a heat conduction auxiliary agent, a flame retardant and a flow improver.

The present application also provides a method of preparing the above thermoplastic crosslinked polyethylene material, comprising the step of heating melt-plasticized extrusion pellets after mixing the raw materials.

Further, the method of preparing the above thermoplastic crosslinked polyethylene material comprises the step of heating a melt to a temperature range of 240° C. to 250° C. for extrusion.

The present application also provides use of the above thermoplastic crosslinked polyethylene material or the thermoplastic crosslinked polyethylene material obtained by the above method for preparing pipes, plates, sheets, bars, hollow containers and mechanical parts.

In the present application, it should be noted that polyethylene is difficult to store under normal conditions, so a polyethylene product is added with a certain antioxidant or other radical scavenger before being put on the market.

The technical solution of the present application has the following advantages:

1. The thermoplastic crosslinked polyethylene material provided in the present application comprises a first polyethylene component that is easily crosslinked, a second polyethylene component that is not easily crosslinked, and an organic peroxide crosslinking agent which participates in the melt blending of the system. The free radicals generated by thermal decomposition capture H atoms on PE macromolecular chains, and PE macromolecules lost the H atoms also form free radicals. These different kinds of free radicals combine with each other to make the linear structure of PE macromolecules chains into a network structure, and even a three dimensional structure. The second polyethylene component that is not easily crosslinked has no or very little crosslinking generated, and still maintains its thermoplasticity. In the present application, the first polyethylene component that is easily crosslinked, is crosslinked in a fine particle form and uniformly dispersed in the second polyethylene component that is not easily crosslinked, and intertwined with the macromolecular chain of the second polyethylene component that is not easily crosslinked. The resulted product is completely thermoplastic, and has properties, such as heat resistance and creep property, superior to the first polyethylene component that is easily crosslinked and the second polyethylene component that is not easily crosslinked. The pipes of the thermoplastic crosslinked polyethylene of the present application can be welded by hot-melting method, and the connection is convenient, and the waste products and waste materials can be recovered by melting method, which reduces the production cost and is beneficial to environmental protection at the same time.

2. The thermoplastic crosslinked polyethylene material provided by the present application uses di-tert-butyl peroxide as a crosslinking agent, and the decomposition temperature thereof is higher than the melting temperature of the first polyethylene component and the melting temperature of the second polyethylene component, which effectively ensures the uniformity of the distribution of the crosslinked PE in the second polyethylene component that is not easily crosslinked. At the same time, the peroxide crosslinker has a short half life, no residue after the reaction, good hygienic performance and meets environmental protection requirements.

3. The thermoplastic crosslinked polyethylene material provided by the present application further comprises an antioxidant component, which reduces the possibility of degradation of macromolecules during high temperature heating, and can effectively prolong the service life of the product.

4. The method of preparing a thermoplastic crosslinked polyethylene material provided by the present application comprises the steps of heating melt-plasticized extrusion pellets after mixing the components of the raw materials evenly. The method has the advantages of using a small amount of the crosslinking agent, sufficient reaction, less residue, meeting the requirements of health and environmental protection, simple process, low cost, and facilitating industrial mass production.

5. The thermoplastic crosslinked polyethylene material provided by the present application can be widely applied to most applications of high density polyethylene, heat resistant polyethylene and crosslinked polyethylene. In addition, after blending modification by a modification method similar to HDPE, the thermoplastic crosslinked polyethylene material of the present application can also prepare a flame-retardant thermoplastic crosslinked polyethylene, an antistatic thermoplastic crosslinked polyethylene, a thermally conductive thermoplastic crosslinked polyethylene, etc., thus its application fields are further expanded.

### DETAILED DESCRIPTION OF THE EMBODIMENTS

The technical solution of the present application will be described clearly and completely hereinafter, and it is obvious that the described examples are a part of the examples of the present application, but not all of the examples of the present application. Based on the examples of the present application, all other examples obtained by one skilled in the art without creative efforts are within the scope of the present application. Further, the technical features involved in the different embodiments of the present application described below may be combined with each other as long as they do not constitute a conflict with each other.

In the following examples, DTBP is di-tert-butane peroxide, DYBP is 2,5-dimethyl-2,5-di-tert-butylperoxy-3-hexyne, antioxidant 1076 is octadecyl 3-(3,5-di-tert-butyl-4-hydroxyphenyl)propionate, antioxidant 1010 is tetrakis[β-(3,5-di-tert-butyl-4-hydroxyphenyl)propionic acid] pentaerythritol ester, antioxidant DLTP is dilauryl thiodipropionate, DLTDP is dilauryl thiodipropionate, BIBP is di-tert-butylperoxy diisopropylbenzene, which is a peroxide crosslinking agent, and KT-12A is PE-g-MAH, that is a maleic anhydride grafted polyethylene resin.

### Example 1

Example 1 provides a thermoplastic crosslinked polyethylene material, comprising the raw materials of 300 g of HDPE, 700 g of PERT, 2.3 g of DTBP, 2.5 g of antioxidant 1076, and 1.5 g of DLTDP.

In the above raw materials, HDPE is high density polyethylene, which contains no antioxidant or other radical scavenger, and is purchased from Sinopec Yangzi Petrochemical Co., Ltd.; PERT is heat resistant polyethylene, which is a copolymer of ethylene monomer and hexene monomer, and is purchased from Sinopec Qilu Petrochemical Company.

The specific method of preparing thermoplastic crosslinked polyethylene particles using the above raw materials is as follows:

The raw materials were weighed according to the above formula, and mixed in a high-speed mixer for 10 minutes. The resulted mixed raw material was put into a twin-screw extrusion granulator for granulating, thereby obtaining the thermoplastic crosslinked polyethylene particles. In this example, the rotate speed of the extruder was 30 rpm, and the temperatures of each section of the extruder were 160° C., 180° C., 200° C., 230° C. and 240° C., respectively.

### Example 2

Example 2 provides a thermoplastic crosslinked polyethylene material, comprising the raw materials of 350 g of HDPE, 650 g of PERT, 2.5 g of DTBP, 2.0 g of antioxidant 1076, and 2.0 g of DLTDP.

In the above raw materials, HDPE is high density polyethylene, which contains no antioxidant or other radical scavenger, and is purchased from Sinopec Yangzi Petrochemical Co., Ltd.; PERT is heat resistant polyethylene, which is a copolymer of ethylene monomer and hexene monomer, and is purchased from Sinopec Qilu Petrochemical Company.

The specific method of preparing thermoplastic crosslinked polyethylene particles using the above raw materials is as follows:

The raw materials were weighed according to the above formula, and mixed in a high-speed mixer for 10 minutes. The resulted mixed raw material was put into a twin-screw extrusion granulator for granulating, thereby obtaining the thermoplastic crosslinked polyethylene particles. In this example, the rotate speed of the extruder was 40 rpm, and the temperatures of each section of the extruder were 160° C., 180° C., 200° C., 230° C. and 245° C., respectively.

### Example 3

Example 3 provides a thermoplastic crosslinked polyethylene material, comprising the raw materials of 450 g of HDPE, 550 g of PERT, 2.8 g of DTBP, 2.5 g of antioxidant 1076, and 2.0 g of DLTDP.

In the above raw materials, HDPE is high density polyethylene, which contains no antioxidant or other radical scavenger, and is purchased from Sinopec Yangzi Petrochemical Co., Ltd.; PERT is heat resistant polyethylene, which is a copolymer of ethylene monomer and hexene monomer, and is purchased from Sinopec Qilu Petrochemical Company.

The specific method of preparing thermoplastic crosslinked polyethylene particles using the above raw materials is as follows:

The raw materials were weighed according to the above formula, and mixed in a high-speed mixer for 10 minutes. The resulted mixed raw material was put into a twin-screw extrusion granulator for granulating, thereby obtaining the thermoplastic crosslinked polyethylene particles. In this example, the rotate speed of the extruder was 50 rpm, and the temperatures of each section of the extruder were 160° C., 180° C., 200° C., 230° C. and 250° C., respectively.

### Example 4

Example 4 provides a thermoplastic crosslinked polyethylene material, comprising the raw materials of 350 g of MDPE, 650 g of PERT, 2.5 g of DTBP, 2.0 g of antioxidant 1076, and 2.5 g of DLTDP.

In the above raw materials, MDPE is medium density polyethylene, which contains no antioxidant or other radical scavenger, and is purchased from Sinopec Yangzi Petrochemical Co., Ltd.; PERT is heat resistant polyethylene, which is a copolymer of ethylene monomer and hexene monomer, and is purchased from Sinopec Qilu Petrochemical Company.

The specific method of preparing thermoplastic crosslinked polyethylene particles using the above raw materials is the same as one in Example 1.

### Example 5

Example 5 provides a thermoplastic crosslinked polyethylene material, comprising the raw materials of 300 g of HDPE, 700 g of PERT, 1.5 g of DYBP, and 4.2 g of antioxidant 1076.

In the above raw materials, HDPE is high density polyethylene, which contains no antioxidant or other radical scavenger, and is purchased from Sinopec Yangzi Petrochemical Co., Ltd.; PERT is heat resistant polyethylene, which is a copolymer of ethylene monomer and hexene monomer, and is purchased from Sinopec Qilu Petrochemical Company.

The specific method of preparing thermoplastic crosslinked polyethylene particles using the above raw materials is the same as one in Example 3.

### Example 6

Example 6 provides a thermoplastic crosslinked polyethylene material, comprising the raw materials of 350 g of HDPE, 650 g of PERT, 2.5 g of DTBP, and 4.2 g of antioxidant 1076.

In the above raw materials, HDPE is high density polyethylene, which contains no antioxidant or other radical scavenger, and is purchased from Sinopec Yangzi Petrochemical Co., Ltd.; PERT is heat resistant polyethylene, which is a copolymer of ethylene monomer and hexene monomer, and is purchased from Sinopec Qilu Petrochemical Company.

The specific method of preparing thermoplastic crosslinked polyethylene particles using the above raw materials is the same as one in Example 3.

### Example 7

Example 7 provides a thermoplastic crosslinked polyethylene material, comprising the raw materials of 400 g of HDPE, 600 g of PERT, 2.8 g of DTBP, and 4.2 g of antioxidant 1076.

In the above raw materials, HDPE is high density polyethylene, which contains no antioxidant or other radical scavenger, and is purchased from Sinopec Yangzi Petrochemical Co., Ltd.; PERT is heat resistant polyethylene, which is a copolymer of ethylene monomer and hexene monomer, and is purchased from Sinopec Qilu Petrochemical Company.

The specific method of preparing thermoplastic crosslinked polyethylene particles using the above raw materials is the same as one in Example 3.

### Example 8

Example 8 provides a thermoplastic crosslinked polyethylene material, comprising the raw materials of 500 g of HDPE, 500 g of PERT, 3.0 g of DTBP, and 4.2 g of antioxidant 1076.

In the above raw materials, HDPE is high density polyethylene, which contains no antioxidant or other radical scavenger, and is purchased from Sinopec Yangzi Petrochemical Co., Ltd.; PERT is heat resistant polyethylene, which is a copolymer of ethylene monomer and hexene monomer, and is purchased from Sinopec Qilu Petrochemical Company.

The specific method of preparing thermoplastic crosslinked polyethylene particles using the above raw materials is the same as one in Example 3.

### Example 9

Example 9 provides a thermoplastic crosslinked polyethylene material, comprising the raw materials of 600 g of MDPE, 400 g of PERT, 3.5 g of DYBP, and 4.2 g of antioxidant 1076.

In the above raw materials, MDPE is medium density polyethylene, which contains no antioxidant or other radical scavenger, and is purchased from Sinopec Yangzi Petrochemical Co., Ltd.; PERT is heat resistant polyethylene, which is a copolymer of ethylene monomer and hexene monomer, and is purchased from Sinopec Qilu Petrochemical Company.

The specific method of preparing thermoplastic crosslinked polyethylene particles using the above raw materials is the same as one in Example 3.

### Example 10

Example 10 provides a thermoplastic crosslinked polyethylene material, comprising the raw materials of 600 g of LDPE, 300 g of HDPE+ antioxidant 1010+ antioxidant DLTP, 3.5 g of BIBP, and 4.2 g of antioxidant 1076.

In the above raw materials, LDPE is low density polyethylene, which contains no antioxidant or other radical scavenger, and is purchased from Sinopec Yangzi Petrochemical Co., Ltd.; HDPE is high density polyethylene, which contains no antioxidant or other radical scavenger, and is purchased from Sinopec Yangzi Petrochemical Co., Ltd. In order to make HDPE have a property of being not easily crosslinked, an appropriate amount of antioxidants 1010 and DLTP are added to HDPE, the appropriate amount is 0.5% by weight of HDPE, respectively. Among them, antioxidant 1010 is used as a primary antioxidant, and antioxidant DLTP is used as a secondary antioxidant, both of them have an excellent free radical scavenging ability.

The specific method of preparing thermoplastic crosslinked polyethylene particles using the above raw materials is as follows:

HDPE, antioxidants 1010 and DLTP were mixed and melt granulated, and then other components of the raw materials were added therein and mixed in a high-speed mixer for 10 minutes. The resulted mixed raw material was put into a twin-screw extrusion granulator for granulating, thereby obtaining the thermoplastic crosslinked polyethylene particles. In this example, the rotate speed of the extruder was 50 rpm, and the temperatures of each section of the extruder were 160° C., 180° C., 200° C., 230° C. and 250° C., respectively.

### Example 11

Example 11 provides a flame-retardant thermoplastic crosslinked polyethylene material, comprising the raw materials of 350 g of HDPE, 650 g of mLLDPE, 2.5 g of BIBP, 2.5 g of antioxidant 1076, 2.0 g of DLTDP, 430 g of HFR23, and 15 g of white oil.

In the above raw materials, HDPE is high density polyethylene, which contains no antioxidant or other radical scavenger, and is purchased from Sinopec Yangzi Petrochemical Co., Ltd.; mLLDPE is metallocene linear low density polyethylene, which is a copolymer of ethylene monomer and hexene monomer containing an appropriate amount of antioxidants. The copolymer is imported from abroad, and purchased from ExxonMobil 3518GA.

The specific method of preparing thermoplastic crosslinked polyethylene particles using the above raw materials is the same as one in Example 3.

### Example 12

Example 12 provides a thermally conductive thermoplastic crosslinked polyethylene material, comprising the raw materials of 350 g of HDPE, 650 g of mLLDPE, 2.5 g of BIBP, 2.5 g of antioxidant 1076, 2.0 g of DLTDP, 220 g of graphite, 60 g of KT-12A, and 12 g of white oil.

In the above raw materials, HDPE is high density polyethylene, which contains no antioxidant or other radical scavenger, and is purchased from Sinopec Yangzi Petrochemical Co., Ltd.; mLLDPE is metallocene linear low density polyethylene, which is a copolymer of ethylene monomer and hexene monomer containing an appropriate amount of antioxidants. The copolymer is imported from abroad, and purchased from ExxonMobil 3518GA.

### Example 13

Example 13 provides pipes of the thermoplastic crosslinked polyethylene material, which was prepared by subjecting the thermoplastic crosslinked polyethylene particles in the example 1 of the application to screen to select particles having a particle diameter of 2˜3 mm. The pipes of the thermoplastic crosslinked polyethylene material were prepared using ordinary HDPE pipe or PERT pipe manufacturing equipment. The pipes should be connected by socket welding, and the waste products can be made into the pipes of the thermoplastic crosslinked polyethylene after being crushed and granulated. The pipes obtained in this example can be used for a hot water system, a drinking water system, a wear resistant, heat resistant and corrosion resistant oil extracting lined pipe, and a working pipe of heat pipeline, etc.

### Example 14

Example 14 provides a conveyor idler of the thermoplastic crosslinked polyethylene material, which was prepared by subjecting the thermoplastic crosslinked polyethylene particles in the example 5 of the application to screen to select particles having a particle diameter of 2˜3 mm, and injection-molding by an injection molding machine to obtain the conveyor idler of the thermoplastic crosslinked polyethylene material, which has properties of wear resistant and corrosion resistant, and can be widely applied to belt conveyors in places such as a salt field or a mine.

### Example 15

Example 15 provides a hollow article of the thermoplastic crosslinked polyethylene material, which was prepared by subjecting the thermoplastic crosslinked polyethylene particles in the example 1 of the application to screen to select particles having a particle diameter of 2˜3 mm, and blow molding by a polyethylene hollow container molding machine to obtain a plastic barrel of 5˜8 L.

### Example 16

Example 16 provides a rotational molding product of the thermoplastic crosslinked polyethylene material, which was prepared by subjecting the thermoplastic crosslinked polyethylene particles in the example 1 of the application to screen to select particles having a particle diameter of 0.2˜0.25 mm, and rotational molding by a rotational molding machine to obtain the rotational molding product of the thermoplastic crosslinked polyethylene material, which has properties of abrasion resistant, heat resistant, corrosion resistant, and high impact resistant.

### Comparative Example 1

Comparative Example 1 provides a hose of polyethylene material, which was prepared by the method of Example 1 in the Chinese patent document CN102875877A.

### Comparative Example 2

Comparative Example 2 provides a pipe of polyethylene material, which was prepared by the same method as in Example 13. The difference of Comparative Example 2 from Example 13 is that high density polyethylene (HDPE) in the raw material of the polyethylene material used in the Comparative Example 2 contains a certain antioxidant, and is purchased from Sinopec Qilu Petrochemical Company.

### Experimental Example 1

A hydrostatic test direct to the thermoplastic crosslinked polyethylene pipes of Example 13 was carried out in accordance with the provisions of GB/T18992.2-2003 Crosslinked polyethylene (PE-X) piping system for hot and cold water (Part 2: Pipes). The test results were shown in Table 1 below.

TABLE 1
Hydrostatic test results of thermoplastic crosslinked polyethylene pipes

| Test temperature/ | Hydrostatic | Test | Whether it has permeation or |
|---|---|---|---|
| ° C. | stress/MPa | time/h | failure? |
| 20 | 12 | 1 | no permeation and no failure |
| 95 | 4.8 | 1 | no permeation and no failure |
| 95 | 4.7 | 22 | no permeation and no failure |
| 95 | 4.6 | 165 | no permeation and no failure |
| 95 | 4.4 | 1000 | no permeation and no failure |

### Experimental Example 2

Performance tests of Example 13, Comparative Example 1, Comparative Example 2, commercially available PE-RTII pipes and commercially available PE-Xa pipes were carried out. The test results were shown in Table 2 below.

TABLE 2
Performance test results of various pipes

| | | | | Commercially | |
|---|---|---|---|---|---|
| | | | | available | Commercially |
| | Example | Comparative | Comparative | PE-RTII | available |
| Items | 13 | Example 1 | Example 2 | pipes | PE-Xa pipes |
| MFR (190° C., | 1.35 g/10 min | — | — | 0.6 g/10 min | — |
| 21.6 kg weight) | | | | | |
| Degree of | 0.7~1.3 | — | 20~35 | — | 70~90 |
| crosslinking/% | | | | | |
| Vicat softening | 126.1 | 120.1 | 126.9 | 121.9 | 127.3 |
| point/° C. | | | | | |
| 20° C. tensile | 7.93e−0.3 | 15.24e−0.3 | 11.47e−0.3 | 13.83e−0.3 | 10.28e−0.3 |
| creep/% | | | | | |
| 95° C. tensile | — | 26.37e−0.3 | — | 24.56e−0.3 | 12.02e−0.3 |
| creep/% | | | | | |
| 110° C. tensile | 17.33e−0.3 | 32.21e−0.3 | 23.32e−0.3 | 28.79e−0.3 | 18.76e−0.3 |
| creep/% | | | | | |
| 30° C. 100% | 17.74 | 14.03 | 17.65 | 14.58 | 17.74 |
| tensile | | | | | |
| modulus/MPa | | | | | |
| 70° C. 100% | 10.96 | 7.17 | 10.13 | 8.92 | 10.96 |
| tensile | | | | | |
| modulus/MPa | | | | | |
| 95° C. 100% | 8.03 | 4.91 | 7.16 | 5.72 | 6.34 |
| tensile | | | | | |
| modulus/MPa | | | | | |
| 110° C. 100% | 5.35 | 3.26 | 5.17 | 4.18 | 5.07 |
| tensile | | | | | |
| modulus/MPa | | | | | |
| bending | 13.03 | 10.4 | 12.87 | 10.54 | 12.72 |
| strength/MPa | | | | | |
| bending | 424 | 247 | 451 | 415 | 527 |
| modulus/MPa | | | | | |
| Impact strength/ | 89.89 | 71.2 | 93.32 | 88.08 | 105.12 |
| KJ/m2 | | | | | |

In table 2, MFR represents the mass flow rate of solution, the test method of which refers to GB/T 3682-2000 (IS01133); Vicat softening point refers to the temperature at which a polymer sample is pressed into a depth of 1 mm by 1 mm² pin in the liquid heat transfer medium at a certain load and a certain constant speed heating condition. The test method of which refers to GB/T1633 “Measurement of Thermoplastic Softening Temperature (VST)”; The test method of tensile creep refers to GB/T11546.1-2008 (150899-1:2003).

It is apparent that the above-described examples are merely examples for clearly illustrating the present application, and are not intended to limit the present application. Based on the above description, other variations or modifications of various forms may be made by one skilled in the art. Here, there is no need and no way to exhaust all examples. The obvious variations or modifications which are derived therefrom are still within the scope of the application.

1. A thermoplastic crosslinked polyethylene material, wherein the thermoplastic crosslinked polyethylene material comprises the following raw materials in parts by weight:
30˜70 parts of a first polyethylene component;
30˜70 parts of a second polyethylene component; and
0.15˜0.35 part of a crosslinking agent;
the first polyethylene component is an ethylene homopolymer free of antioxidants or other free radical scavengers;
the second polyethylene component is an ethylene homopolymer containing antioxidants or other free radical scavengers, or a copolymer of ethylene and a non-ethylene monomer.

2. The thermoplastic crosslinked polyethylene material according to claim 1, wherein the non-ethylene monomer is one or more of butene, hexene and octene.

3. The thermoplastic crosslinked polyethylene material according to claim 1, wherein the thermoplastic crosslinked polyethylene material comprises the following raw materials in parts by weight:
35 parts of the first polyethylene component;
65 parts of the second polyethylene component; and
0.25 part of an organic peroxide crosslinking agent;
the first polyethylene component is an ethylene homopolymer free of antioxidants or other free radical scavengers;
the second polyethylene component is a copolymer of ethylene and hexene monomer.

4. The thermoplastic crosslinked polyethylene material according to claim 3, wherein the organic peroxide crosslinking agent is one or more of di-tert-butane peroxide, 2,5-dimethyl-2,5-di-tert-butylperoxy-3-hexyne or di-tert-butylperoxy diisopropylbenzene.

5. The thermoplastic crosslinked polyethylene material according to claim 1, further comprising an antioxidant, the antioxidant is dilauryl thiodipropionate and/or octadecyl 3-(3,5-di-tert-butyl-4-hydroxyphenyl)propionate.

6. The thermoplastic crosslinked polyethylene material according to claim 1, comprising one or more of a conductive auxiliary agent, a heat conduction auxiliary agent, a flame retardant and a flow improver.

7. A method of preparing the thermoplastic crosslinked polyethylene material according to claim 1, comprising the step of heating melt-plasticized extrusion pellets after mixing the raw materials.

8. The method of claim 7, further comprising the step of heating a melt to a temperature of 240° C. to 250° C. for extrusion.

9. (canceled)

10. A method of preparing pipes, plates, sheets, bars, hollow containers and mechanical parts, comprising the step of using the thermoplastic crosslinked polyethylene material according to claim 1, the thermoplastic crosslinked polyethylene material obtained by heating melt-plasticized extrusion pellets after mixing the raw materials for preparing pipes, plates, sheets, bars, hollow containers and mechanical parts.

11. The thermoplastic crosslinked polyethylene material according to claim 2, wherein the thermoplastic crosslinked polyethylene material comprises the following raw materials in parts by weight:
35 parts of the first polyethylene component;
65 parts of the second polyethylene component; and
0.25 part of an organic peroxide crosslinking agent;
the first polyethylene component is an ethylene homopolymer free of antioxidants or other free radical scavengers;
the second polyethylene component is a copolymer of ethylene and hexene monomer.

12. The thermoplastic crosslinked polyethylene material according to claim 2, further comprising an antioxidant, the antioxidant is dilauryl thiodipropionate and/or octadecyl 3-(3,5-di-tert-butyl-4-hydroxyphenyl)propionate.

13. The thermoplastic crosslinked polyethylene material according to claim 3, further comprising an antioxidant, the antioxidant is dilauryl thiodipropionate and/or octadecyl 3-(3,5-di-tert-butyl-4-hydroxyphenyl)propionate.

14. The thermoplastic crosslinked polyethylene material according to claim 4, further comprising an antioxidant, the antioxidant is dilauryl thiodipropionate and/or octadecyl 3-(3,5-di-tert-butyl-4-hydroxyphenyl)propionate.

15. The thermoplastic crosslinked polyethylene material according to claim 10, further comprising an antioxidant, the antioxidant is dilauryl thiodipropionate and/or octadecyl 3-(3,5-di-tert-butyl-4-hydroxyphenyl)propionate.

16. The thermoplastic crosslinked polyethylene material according to claim 2, comprising one or more of a conductive auxiliary agent, a heat conduction auxiliary agent, a flame retardant and a flow improver.

17. The thermoplastic crosslinked polyethylene material according to claim 3, comprising one or more of a conductive auxiliary agent, a heat conduction auxiliary agent, a flame retardant and a flow improver.

18. The thermoplastic crosslinked polyethylene material according to claim 4, comprising one or more of a conductive auxiliary agent, a heat conduction auxiliary agent, a flame retardant and a flow improver.

19. The thermoplastic crosslinked polyethylene material according to claim 5, comprising one or more of a conductive auxiliary agent, a heat conduction auxiliary agent, a flame retardant and a flow improver.

20. The thermoplastic crosslinked polyethylene material according to claim 10, comprising one or more of a conductive auxiliary agent, a heat conduction auxiliary agent, a flame retardant and a flow improver.

21. The thermoplastic crosslinked polyethylene material according to claim 11, comprising one or more of a conductive auxiliary agent, a heat conduction auxiliary agent, a flame retardant and a flow improver.
